(19) United States
(12) Patent Application Publication
(10) Pub. No.: US 2006/0162505 A1
(43) Pub. Date: Jul. 27, 2006

(54) Lock nut and wrench for leg assembly of home appliance

(76) Inventors: Kang Mo Choi, Hoewon-gu (JP); Sung Rak Gong, Busanjin-gun (JP); Dae Hee Kwon, Yeongdo-gu (KR)

Correspondence Address: MCKENNA LONG & ALDRIDGE LLP, 1900 K STREET, NW, WASHINGTON, DC, 20006, US

(21) Appl. No.: 10/529,239

(22) PCT Filed: May 19, 2004
(86) PCT No.: PCT/KR04/01180

§ 371 Date: Mar. 25, 2005

(30) Foreign Application Priority Data
May 20, 2003 (KR) 10-2003-0031956
May 20, 2003 (KR) 10-2003-0031957
May 20, 2003 (KR) 10-2003-0031954

(51) Int. Cl. B25B 13/56; B25B 13/02; B25B 13/06

(52) U.S. Cl. 81/119; 81/121.1; 81/176.1

(57) ABSTRACT

Disclosed are lock nuts (100) and (100a) for preventing a leg bolt (4) from loosening from a leg assembly supporting electric home appliances, and a wrench (500) for loosening or tightening the lock nuts (100) and (100a′). The lock nuts (100) and (100a′) includes a hub having a screw hole (111), a plurality of ribs extended in a radius direction from a circumferential surface of the hub, and having sides (125) and (125a′) over which the wrench (500) or a finger is hooked, and supplementary member (130) provided allowing the wrench or finger to access form the radius direction of the hub to the sides (125) and (125a′), and coupling the ribs (120). The wrench (500) includes a long grip having at least one projection (550) and (560) on an outer circumferential surface thereof, and a box end (530) or an open end (520) provided at either of both ends thereof.

### TECHNICAL FIELD

The present invention relates to a lock nut and wrench for leg assembly of home appliance, and more particularly, to a lock nut and wrench for preventing leg bolt from being escaped from leg assembly supporting home appliances such as a washing machine or clothes dryer.

### BACKGROUND ART

Legs for an electric home appliance, in general, are provided at a lower part thereof for supporting the electric home appliance. In a case of legs applied to the electric home appliance of which life span and reliable operation are greatly influenced by an installation condition, the legs normally includes a screw structure for easily controlling a height of the electric home appliances at each corner thereof. In FIG. 1, an example showing a general leg assembly having the screw structure is provided to the electric home appliances. Hereinafter, the leg assembly will be described in more detail referring to FIG. 1.

A screw hole 2a is provided at a base including a lower part of an electric home appliance, and a leg bolt 4 having a broad head 4a in contact with a floor is coupled with the screw hole 2a. In this case, the leg bolt may include an angled head 4b for easily tighten to loosen a screw by using a tool such as a wrench having an open end 5a and a box end at both ends of a grip 5a as illustrated in FIG. 3.

For preventing the leg bolt 4 from being escaped, the leg assembly further includes a washer 3 and a lock nut 1 illustrated in FIG. 2. In this case, the washer 3 is coupled with the base 2 so as to lie on the screw hole 2a as illustrated in FIG. 2, and the lock nut 1 is coupled with the leg bolt 4 so as to closely adhered to the washer 3.

For adjusting the height of the leg assembly having the abovementioned structure, the height of the leg bolt 4 is controlled by loosening the lock nut 1 closely adhered to the washer 3 and rotating the leg bolt 4, and then the lock nut 1 is tightened to be closely adhered to the washer 3. In a case of the lock nut 1, the lock nut 1 has a shape not only difficult to hold by hands, but difficult to rotate by using the wrench illustrated in FIG. 3.

Accordingly, during an initial rotation (loosening) of the lock nut 1 needed a large torque and during a last rotation (tightening), a worker has a great deal of difficulty in rotating the lock nut 1, thereby resulting in a possibility of loosening the lock nut 1 in short of power for tightening the lock nut 1, and a problem of low work efficiency during installation of the leg assembly or during controlling the height of the leg assembly.

### DISCLOSURE OF INVENTION

Accordingly, the present invention is directed to a lock nut for a leg assembly of electric home appliances that substantially obviates one or more problems due to limitations and disadvantages of the related art.

An object of the present invention is to provide a lock nut for a leg assembly of electric home appliances and a wrench for loosening or tightening the same such that a worker can easily loosen or tighten the lock nut.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the lock nut for the leg assembly of electric home appliances includes a hub having a screw hole through which a leg bolt coupled with the electric home appliances; a plurality of ribs extended in a radius direction from a circumferential surface of the hub, and having sides 125 and 125a over which the wrench 500 or a finger is hooked; and a supplementary member 130 provided allowing the wrench or finger to access from the radius direction of the hub to the sides 125 and 125a, and coupling the ribs 120.

In this case, it is desirable that the height of the rib is same as or lower than that of the hub, and the height of the supplementary member is lower than that of the rib. Meanwhile, it is desirable that the side is perpendicular to a horizontal plane, or is inclined to a perpendicular line.

At least one of both sides of the rib gets gradually larger from the hub toward an end of the rib, and an end portion and both sides of the rib are geared to the tool when the tool accessed from the radius direction of the hub.

Meanwhile, the supplementary member comprises an extension member extended from a circumference of the hub to a space between the ribs. In this case, a first side of both sides of the rib is inclined such that it gets gradually thicker from an upper part of the rib to the extension member, and a second side thereof is inclined such that it gets thicker from a lower part of the rib to the extension member.

In addition, the extension member is inclined such that the tool or finger accessed from the radius direction of the hub easily touches the side. In this case, the extension member is inclined such that a first end of thereof being coupled with the hub is higher than a second end thereof being adjacent to the end portion of the rib.

In the mean time, an end portion of the extension is provided to be adjacent to a lower part or upper part of an end portion of the rib such that a single exposed area of a portion being adjacent to the end portion of the rib on the side becomes larger.

It is desirable that a center portion of the end portion of the extension member is curved toward the hub, the end portion of the rib forms a corner of the lock nut, and the end portion of the rib is rounded.

Meanwhile, the supplementary member includes a rim for coupling the end portion of the ribs. In this case, it is desirable that the rim is lower than the rib and is coupled with an upper or lower part of the rib, and is provided to be perpendicular to a horizontal plane. It is desirable that one of two rims located at both sides of the end portion of the rib is coupled with the upper part of the rib, and the other rim is coupled with the lower part thereof. Meanwhile, the coupling portion of the rib, the extension member, and the rim is rounded.

In another aspect of the present invention, a wrench is provided, the wrench including a long grip having at least one projection on an outer circumferential surface thereof; and a box end or an open end provided at either of both ends thereof.

In this case, the projection is provided at a coupling part of the grip and the box end, or at a coupling part of the grip and the open end. In this case, it is desirable that the coupling part is curved. In the mean time, the projection is a hook hooked over a projected portion of the outer circumferential surface, and a gear tooth-geared to the outer circumferential surface of the nut to loosen.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a cut-away view showing a leg assembly of general electric home appliances;

FIG. 2 illustrates a floor plan showing a lock nut of the leg assembly of FIG. 1;

FIG. 3 illustrates a floor plan showing a general wrench used for disassembling the leg bolt of the leg assembly of FIG. 1;

FIG. 4 illustrates a perspective view showing a lock nut in accordance with a first preferred embodiment of the present invention;

FIG. 5 illustrates a floor plan showing the lock nut of FIG. 4;

FIG. 6 illustrates a cut-away view showing a leg assembly to which the lock nut in accordance with the first embodiment of the present invention is applied;

FIG. 7 illustrates a perspective view showing a modified embodiment of the lock nut of FIG. 4;

FIG. 8 illustrates a floor plan showing a lock nut of FIG. 7;

FIG. 9 illustrates a floor plan showing a wrench in accordance with a second preferred embodiment of the present invention;

FIG. 10 illustrates a floor plan showing an example of the use of the wrench of FIG. 9;

FIG. 11 illustrates a perspective view showing a modified embodiment of the wrench of FIG. 9; and

FIG. 12 illustrates a floor plan showing an example of the use of the wrench of FIG. 11.

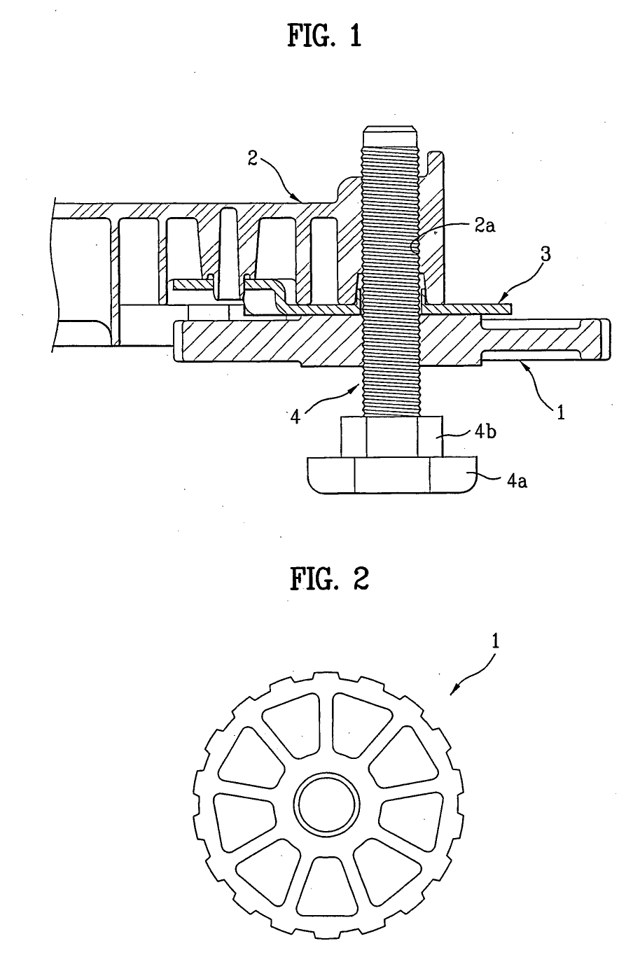

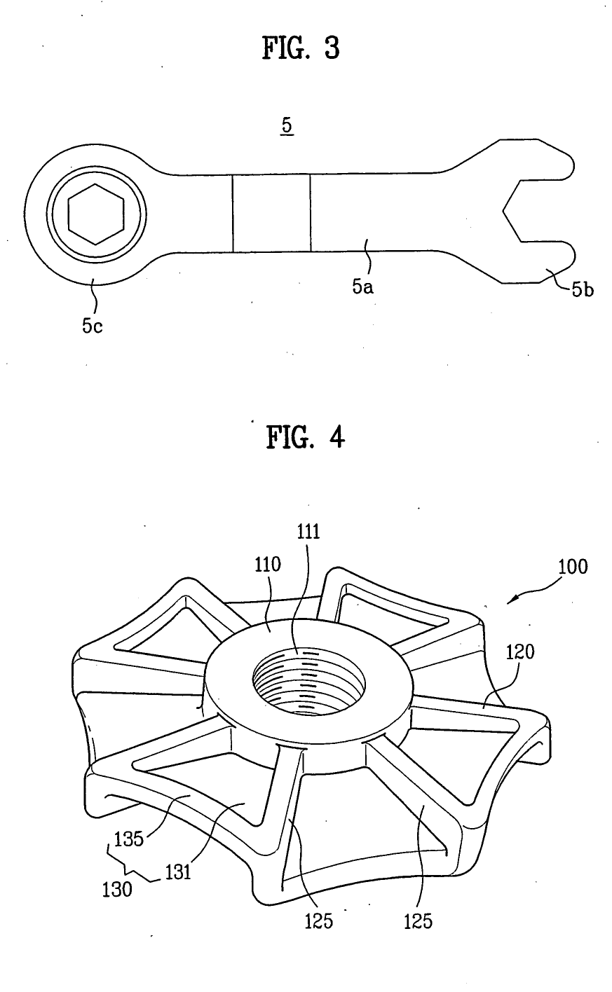

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

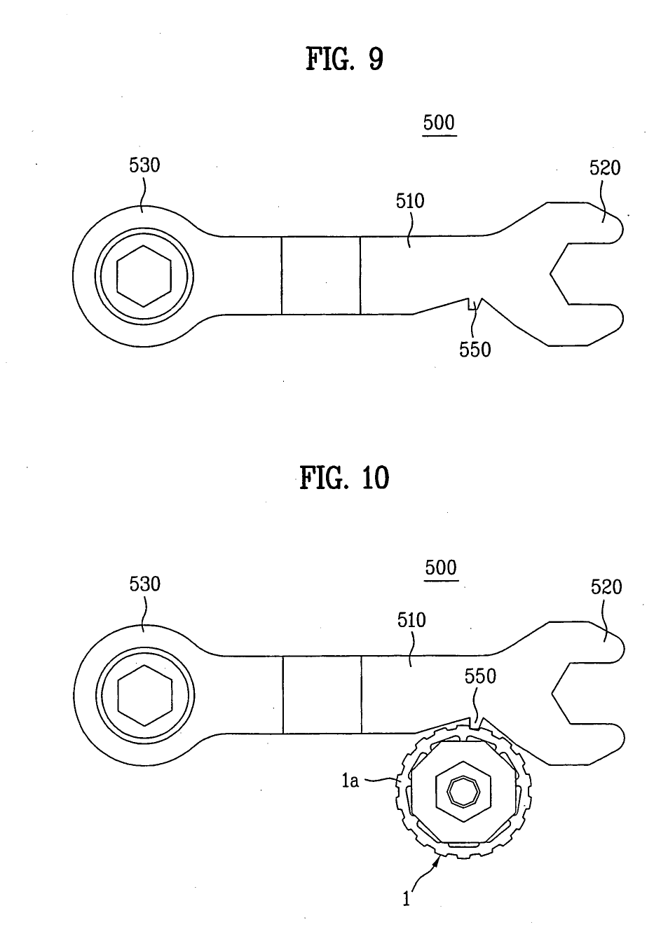

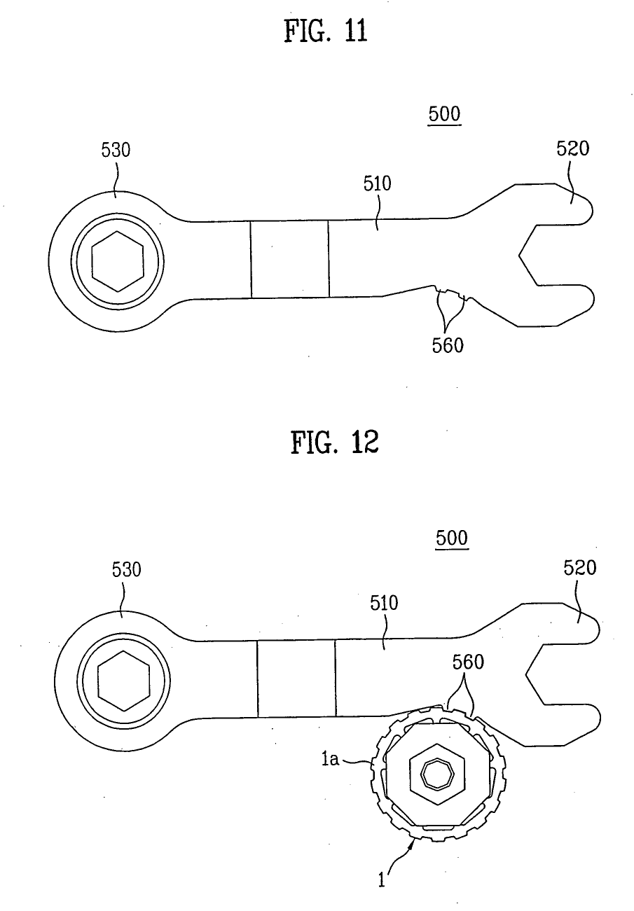

In the present invention, various examples are provided for assembling or disassembling the leg assembly of electric home appliances. For example, a structure of a lock nut is improved for preventing a leg bolt in a first embodiment and in a modified embodiment of the first embodiment as illustrated in FIG. 4 to FIG. 8, and a structure of a wrench for tightening or loosening the leg bolt is improved in a second embodiment or in a modified embodiment of the second embodiment as illustrated in FIG. 9 to FIG. 12. Therefore, hereinafter, the present invention will be described in more detail referring to drawings by each embodiment.

### First Embodiment and Modified Embodiment Thereof

In accordance with a first embodiment and a modified embodiment of the same in the present invention, a structure of a lock nut is improved for solving conventional problems, which will be described in more detail, hereinafter.

First, referring to FIG. 4, the lock nut 100 in accordance with the first embodiment of the present invention includes a hub 110, a rib 120, and a supplementary member 130.

The hub 110 is formed of a cylindrical form having a predetermined height, and a screw hole 111 is provided passing an upper surface and a lower surface of the hub 110. As a reference, a leg bolt 4 is coupled to the screw hole 111 to pass through the hub 110, and the leg bolt 4 is coupled with a base 2 of an electric home appliance Refer to FIG. 6).

The rib 120 is extended in a radius direction from a circumference of the hub 110. A plurality of ribs 120 having a same length is arranged at same intervals along the circumference of the hub 110. In this case, height of the rib 120 is same as or a little smaller than that of the hub 110.

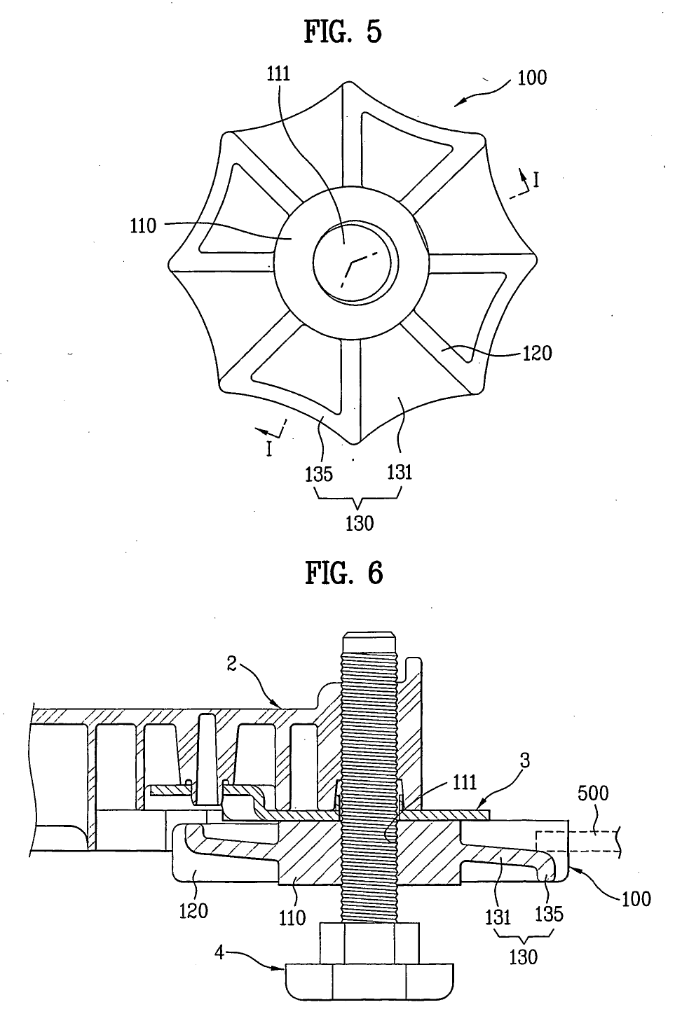

The rib 120 includes a side 125 over which a tool such as a wrench 500 or a finger accessed from the radius direction of the hub 110 is hooked for rotating the hub about the leg bolt 4 (Refer to FIG. 6). In this case, the side 125 is provided to be perpendicular to a horizontal plane as illustrated in FIG. 4 and FIG. 5.

The supplementary member 130 performs a role of increasing strength of the lock nut 100 by coupling the plurality of ribs 120. The supplementary member 130 is arranged to allow the wrench 500 or the finger to access to the side 125 of the rib 120, and the structure of which will be described in detail as follows.

First, the supplementary member 130 is formed to have a lower height than the rib 120 so as to secure a space for the wrench 500 or the finger to access to the side 125 of the rib 120 from the radius direction of the hub 110. The supplementary member 130, for example, includes at least one of either an extension member 131 or a rim 135 as illustrated in FIG. 4. Hereinafter, the extension member 131 and the rim 135 will be described in more detail.

The extension member 131 is extended from the circumference of the hub 110 to a space between the ribs 120 as illustrated in FIG. 4. The extension member 131 is coupled not only to the hub 110 but also to the sides of the ribs 120, respectively. Therefore, stiffness of the ribs 120 with a long length is effectively supplemented.

The extension member 131 is formed to have enough space between two ribs 120 and an upper surface of the extension member 131, or between two ribs 120 and a lower surface of the extension 131 such that the wrench or the finger is easily inserted from the radius direction of the hub 110 into the space between each of the plurality of ribs 120, and thus easily accessed to the side 125 of the plurality of ribs 120.

An end portion of the rib 120 and the end portion of the extension 131 are adjacently provided at a lower part or an upper part of the rib 120. Then the space between the two ribs 120 and the extension 131, i.e., the space wherein the wrench 500 or the finger is accessed from the radius direction of the hub 110 to the side 125 of the rib 120. In addition, an exposed area adjacent to the end of the rib 120 on the side 125 of the rib 120, i.e., the area contactable by the wrench 500 or the finger becomes larger.

Meanwhile, the extension member 131 is provided for supplementing the stiffness of the plurality of ribs 120, sufficiently. The extension member 131 is extended from middle of a height direction of the hub, and a first end of the hub 110 is provided to be higher or lower than a second end adjacent to an outer end portion of the rib 120. In this case, the extension member 131 is provided to have a lower height than the rib 120.

Inclination direction of two extensions located at both sides of one rib 120 is different from each other as illustrated in FIG. 4. In other words, if a predetermined extension member 131 is gradually raised from the hub to the end portion of the rib 120, other two extension members 131 located at both sides of the predetermined extension member 131 become lower from the hub 110 to the end portion of the rib 120.

If structured as abovementioned, not only the extension member 131 is coupled to a side of the rib 120, but also stiffness of the rib 120 is effectively supplemented because the inclination direction of the two extension members 131 coupled with both sides of one rib 130 is different from each other.

And, if structure as aforementioned, a broad space is provided to the side of the rib 120 adjacent to the end portion of the rib 120 such that the wrench or finger can be easily accessed to the side 125.

Meanwhile, the outer circumferential surface of the lock nut 100 is formed in an angled form instead of a round form. For this, the end portion of the rib 120 is projected to have an edge of the lock nut 100 and a center of the end portion of the extension member 131 is curved toward the hub 110 as illustrated in FIGS. 4 and 5.

In the mean time, the rim 135 is coupled with the end portion of the rib 120 as illustrated in FIG. 4. The rim 135 having a smaller height than the rib 120 is coupled with the upper part or lower part of the rib 120. It is to allow the wrench or finger to easily reach to the side 125 of the rib 120 as described in the description of the extension member 131.

The rim 135 is provided to be horizontal. And, as illustrated in FIG. 6, one of the two rims provided at both sides of the end portion of the rib 120 is coupled to the upper part of the rib 120, and the other is coupled to the lower part of the rib 120 such that the stiffness of the two ribs 120 adjacent to each other is effectively increased, and space is secured for wrench or finger to be easily accessed from the radius direction of the hub 110 to the side 125 of the rib 120.

Meanwhile, when both the extension member 131 and the rim 135 are provided at the supplementary member 130, the rim 135 is coupled with the end portion of the rib 120 and the end of the extension member 131. In this case, the rim 135 is perpendicularly extended from the end portion of the extension member 131 to the upper part or lower part of the rib 120.

In more detail, when the extension member 131 is inclined toward an opposite side of the side adjacent to the hub 110, the rim 135 is perpendicularly extended from the end portion of the extension member 131 to the upper part of the rib 120. And, when the extension member 131 is declined toward an opposite side of the side adjacent to the hub 110, the rim 135 is perpendicularly extended from the end portion of the extension member 131 to the lower part of the rib 120. In the mean time, the coupling part of the rim 135, the extension member 131 and the rib 120 is round, but not sharp.

The lock nut 100, in accordance with the present invention, with the abovementioned structure, has an upper surface and a lower surface having no direction and formed in a same form. In other words, when the lock nut 100 is turned over and rotated to a predetermined angle, the form of the lock nut 110 is the same as that, before the rotation and turning over.

Accordingly, it is convenient that a worker can provide the lock nut 100 to the leg assembly of the electric home appliance without thinking about which side of the upper surface or the lower surface to be up.

The lock nut 100, in accordance with the present invention, is used to fix the leg bolt 4 to the leg assembly coupled to the base 2 of the electric home appliance as illustrated in FIG. 6. Hereinafter, a process of loosening or tightening the lock nut 100 will be described referring to FIG. 6. As a reference, a section of the lock nut 100 in FIG. 6 is a cut-away section, taken from the line I-I of FIG. 5.

First, if it were desired to adjust the height of the leg bolt 4 when the leg assembly is provided at the base 2 of the electric home appliance, the lock nut 100 is loosen. In this case, an open end of the wrench 500 is accessed from the radius direction of the hub 110 to the end portion of the rib 120. Then, the open end of the wrench 500 is in gear with the end portion of the rib 120 and with both sides of the side 125 as illustrated in FIG. 6. And, in this instance, the open end of the wrench 500 is located between the two rims 135 each coupled with the upper part and lower part of the rib 120, respectively.

In this instance, the wrench 500 is strongly pulled or pushed so as to rotate in a direction for easing the lock nut 100. Then, the open end of the wrench 500 is transformed as the open end is caught by the side of the rib 120, resulting in easily easing the lock nut 100.

In the mean time, although the lock nut is strongly rotated at a first time, the lock nut 100 is easily rotated with a small amount of power after the lock nut 100 is rotated a couple of times. Accordingly, after rotating the lock nut 100 by using the wrench, the lock nut 100 is eased by holding the angled outer circumferential surface of the lock nut 100 and rotating the lock nut. In this instance, the lock nut may be rotated by being pulled or pushed with a finger inserted between the ribs 120, and closely adhered on the side 125 of the rib 120.

Once the lock nut 100 is completely eased, the height of the leg bolt 4 is adjusted by rotating the leg bolt 4 about the base 2 of the electric home appliance. After the height of the leg bolt 4 is adjusted, the lock nut 100 is tightened back.

The lock nut 100 in accordance with the first embodiment of the present invention has a structure wherein the wrench or finger is easily accessed from the radius direction of the hub 110 to the side supporting the wrench 500 or the finger, i.e., to the side 125 of the rib 120. Therefore, when the electric home appliance is installed, or when the height of the leg bolt 4 is adjusted, the work is easily done with the wrench 500 or the finger.

Meanwhile, although the lock nut 100 in accordance with the first embodiment of the present invention is loosened or tightened by using the wrench or finger, an area to be touched by the finger is small because the side of the rib 120 is perpendicular to the horizontal plane. Therefore, the present invention further includes a lock nut 100a in accordance with the first embodiment of the present invention for the worker to conveniently operate by using the finger, which will be described in more detail.

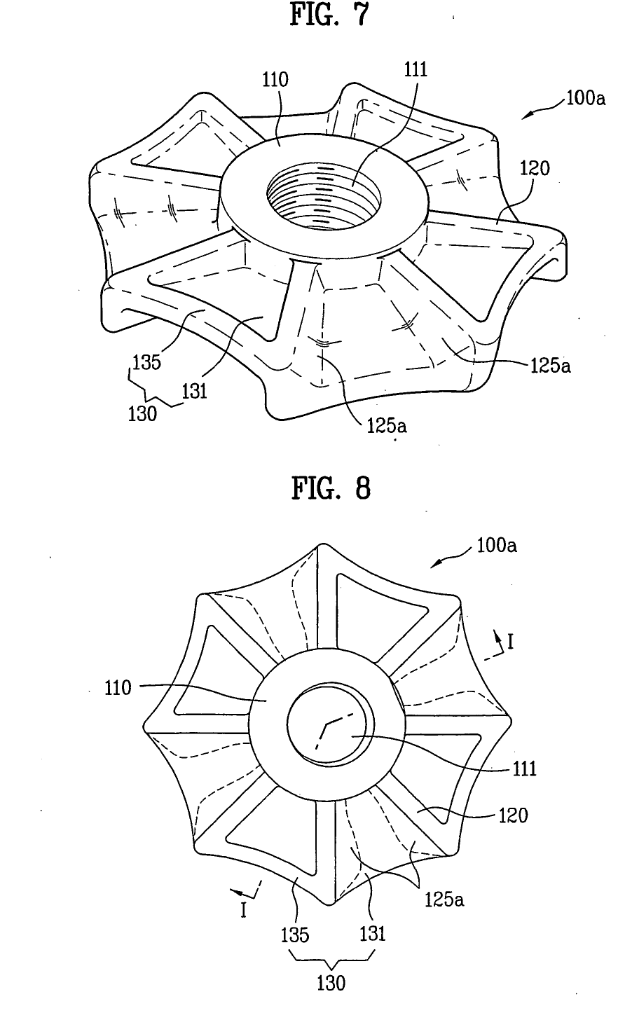

The lock nut 100a in accordance with the first embodiment of the present invention has a very similar structure as the lock nut 100 in accordance with the present invention, the lock nut 100 described referring to FIGS. 4 and 5, as illustrated in FIGS. 7 and 8. Compared to the side 125 of the lock nut 100 in accordance with the first embodiment of the present invention, a side 125a of the rib 120 includes a larger area, the side 125a over which the wrench 500 or finger is hooked.

The side 125a of the lock nut 100a is inclined to the perpendicular surface as illustrated in FIG. 7. In other words, the side 125a of the rib 120 provided between the upper end of the rib 120 and the upper surface of the extension member, and the side 125a of the rib provided between the lower part of the rib 120 and the lower part of the extension member 131 are inclined to the perpendicular surface, respectively.

In this case, a first side of both sides 125a of the rib 120 is inclined so as to be gradually thickened from the upper part of the rib 120 to the extension member 131, and more particularly, to the upper surface of the extension member 131 having an end portion provided adjacent to the lower part of the rib 120. A second side of the both side 125a of the rib 120 is inclined so as to be gradually thickened from the lower part of the rib 120 to the extension member 131, more particularly, to the lower surface of the extension member 131 having an end portion provided adjacent to the upper part of the rib 120.

In the mean time, at least one of the inclined side 125a is provided to have a broader area from the hub 110 to an end portion of the rib 120. Then, the surface directly touched by the wrench or finger accessed from radius direction of the hub 110 to the center thereof, i.e., the side 125a adjacent to the end portion of the rib 120 has a broader area.

When the side 125a of the rib 120 is inclined, the surface touchable by the wrench 500 or finger becomes broader. Therefore, the worker can directly loosen or tighten the lock nut 100a by using not only the wrench but also the finger, with a large force.

As abovementioned, according to the first embodiment and the modified embodiment, the structure of the lock nut 100 and 100a for fixing the leg bolt 4 is improved such that the worker can operate conveniently and precisely.

### Second Embodiment and Modified Embodiment

The structure of a tool, such as a wrench, for loosening a lock nut and a leg bolt is improved in the second embodiment and modified embodiment of the present invention to solve the conventional problem, which will be described in more detail referring to FIG. 9 to FIG. 12.

First, referring to FIG. 9 to FIG. 12, the wrench 500, in accordance with the second embodiment and modified embodiment of the present invention, includes a grip 510, at least one open end 520 or a box end 530 coupled to the grip 510, and at least one projection provided on an outer circumferential surface of the grip 510.

In this case, the grip 510 being a portion a worker holds with hands has a long length. The open end 520 and the box end 530 are provided, respectively, at both ends of the grip 510 for loosening or tightening each bolt or nut. The open end 520 or the box end 530 may be provided only at one of the two ends of the grip 510, or only one of the open box 520 and the box end 530 may be provided to both of the two ends of the grip 510.

Meanwhile, the projections 550 and 560 are provided at a coupling portion coupling the grip 510 with the open end 520 on the outer circumferential surface of the grip, or a portion coupling the grip 510 with the box end 530 as illustrated in FIG. 9 to FIG. 12. Then, even though the worker holds the grip 510 with hands, the hands of the worker does not touch the projections 550 and 560. It is, however, not limited to this, but the projections 550 and 560 may be provided in another place on the outer circumferential surface of the grip 510, or on the outer circumferential surfaces of the open end 520 and of the box end 530.

The projections 550 and 560 provided at the coupling portion are curved as illustrated in FIG. 9 to FIG. 12. In this case, curvature of the coupling portion is the same as or similar to that of an outer circumferential surface of a lock nut 1 to be loosen, particularly the lock nut 1 fixing the leg bolt.

Meanwhile, a hook 550 is provided to the projection 550 at the wrench 600 in accordance with the present invention as illustrated in FIG. 9 and FIG. 10. In this case, the hook 550 is formed to hook over the protrusion or a gear tooth 1a provided on the outer circumferential surface of the lock nut 1 as illustrated in FIG. 10. The hook 550 may be provided at the coupling portion.

On the other hand, a gear tooth 560 is provided to the projection at the wrench 550 in accordance with the second embodiment of the present invention. In this case, the gear tooth 560 is geared to a plurality of gear tooth 1a provided on the outer circumferential surface of the lock nut 1. One gear tooth 560 may be provided at the coupling portion, however, it is desirable that two or more gear tooth 560 are provided.

When using the wrench 500 in accordance with the second embodiment and modified embodiment of the present invention having the structure above-mentioned, the user holds the grip 510, hooks or gears the projections 550 and 560 over the protrusion or gear tooth 1a provided on the outer circumferential surface of the lock nut 1, and rotates the lock nut 1.

Then, the lock nut 1 is loosened or tightened with a large force such that the worker can operate conveniently when installing electric home appliances to the leg assembly, or when adjusting the height of the leg bolt.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

As aforementioned, a lock nut with an improved structure is provided, enabling a worker easily loosen or tighten the lock nut by using a tool or finger, in accordance with the first embodiment or modified embodiment of the present invention.

In the second embodiment and modified embodiment of the present invention, a wrench with an improved structure is provided, enabling a worker loosen or tighten the lock nut after hooking or gearing the lock nut over on an outer circumferential surface of the lock nut.

Accordingly, the worker can install a leg assembly or adjust the height of the leg assembly very easily and conveniently by using the lock nut and wrench in accordance with the present invention. Therefore, the time for assembling the electric home appliance is reduced and productivity is increased, and work efficiency is increased during installing the leg assembly or adjusting the height thereof.

What is claimed is:

1. A lock nut for a leg assembly of electric home appliances, comprising:
a plurality of ribs extended in a radius direction from a circumference of a hub, and having a side over which a tool or finger for rotating the hub about the leg bolt; and
a supplementary member provided allowing the wrench or finger to access from the radius direction of the hub to the side, and coupling the ribs.

2. The lock nut as claimed in claim 1, wherein the height of the rib is same as or lower than that of the hub, and the height of the supplementary member is lower than that of the rib.

3. The lock nut as claimed in claim 1, wherein the side is perpendicular to a horizontal plane.

4. The lock nut as claimed in claim 1, wherein the side is inclined to a perpendicular line.

5. The lock nut as claimed in claim 1, wherein at least one of both sides of the rib gets larger from the hub toward an end of the rib.

6. The lock nut as claimed in claim 1, wherein an end portion and both sides of the rib are geared to the tool when the tool accessed from the radius direction of the hub.

7. The lock nut as claimed in claim 1, wherein the supplementary member comprises an extension member extended from a circumference of the hub to a space between the ribs.

8. The lock nut as claimed in claim 7, wherein the side is inclined to a perpendicular line

9. The lock nut as claimed in claim 8, wherein a first side of both sides of the rib is inclined so as to be gradually thickened from an upper part of the rib to the extension member, and a second side thereof is inclined such that it gets thicker from a lower part of the rib to the extension member.

10. The lock nut as claimed in claim 7, wherein the extension member is extended from a center of a height direction of the hub, and has a lower height than the rib.

11. The lock nut as claimed in claim 7, wherein the extension member is inclined such that the tool or finger accessed from the radius direction of the hub easily touches the side.

12. The lock nut as claimed in claim 7, wherein the extension member is inclined such that a first end of thereof being coupled with the hub is higher than a second end thereof being adjacent to the end portion of the rib.

13. The lock nut as claimed in claim 12, wherein the incline direction of two extensions located at both sides of the rib is different from each other.

14. The lock nut as claimed in claim 7, wherein an end portion of the extension is provided to be adjacent to a lower part or upper part of the end portion of the rib such that a single exposed area of a portion being adjacent to the end portion of the rib on the side becomes larger.

15. The lock nut as claimed in claim 7, wherein a center portion of the end portion of the extension member is curved toward the hub.

16. The lock nut as claimed in claim 7, wherein an end portion of the rib forms a corner of the lock nut.

17. The lock nut as claimed in claim 7, wherein an end portion of the rib is rounded.

18. The lock nut as claimed in claim 1, wherein the supplementary member comprises a rim for coupling the end portion of the ribs.

19. The lock nut as claimed in claim 18, wherein the rim is lower than the rib and coupled with an upper or lower part of the rib.

20. The lock nut as claimed in claim 18, wherein the rim is provided to be perpendicular to a horizontal plane.

21. The lock nut as claimed in claim 18, wherein one of two rims located at both sides of the end portion of the rib is coupled with the upper part of the rib, and the other rim is coupled with the lower part thereof.

22. A lock nut for a leg assembly of electric home appliances, comprising:
a hub having a screw hole through which a leg bolt passes, the leg bolt coupled with an electric home appliance;
a plurality of ribs extended in a radius direction from a circumference of the hub, and having a side over which a tool or a finger accessed from the radius direction of the hub is hooked so as to rotate the hub about the leg bolt.

23. The lock nut as claimed in claim 1, wherein the side is perpendicular to a horizontal plane.

24. The lock nut as claimed in claim 1, wherein the side is inclined to the perpendicular plane.

25. The lock nut as claimed in claim 24, wherein a first side of both sides of the rib is inclined such that it gets thicker from an upper part of the rib to the extension
member, and a second side thereof is inclined such that it gets thicker from a lower part of the rib to the extension member.

26. The lock nut as claimed in claim 22, wherein the extension member is inclined such that a first end of thereof being coupled with the hub is higher than a second end thereof being adjacent to the end portion of the rib.

27. The lock nut as claimed in claim 26, wherein the inclination directions of the two extension members provided at both sides of the rib are different from each other.

28. The lock nut as claimed in claim 22, wherein the rim is perpendicularly extended from the end of the extension member to an upper part or lower part of the rib.

29. The lock nut as claimed in claim 22, wherein one of two rims located at both sides of the end portion of the rib is coupled with the upper part of the rib, and the other rim is coupled with the lower part thereof.

30. The lock nut as claimed in claim 22, wherein the coupling portion of the rib, the extension member and the rim is rounded.

31. A wrench comprising:
a long grip having at least one projection on an outer circumferential surface thereof; and a box end or an open end provided at either of both ends thereof.

32. The wrench as claimed in claim 31, wherein the projection is provided at a coupling part of the grip and the box end, or at a coupling part of the grip and the open end.

33. The wrench as claimed in claim 32, wherein the coupling part is curved.

34. The wrench as claimed in claim 31, wherein the projection is a hook hooked over a projected portion of the outer circumferential surface.

35. The wrench as claimed in claim 31, wherein the projection is a gear tooth geared to the outer circumferential surface of the nut to be loosen.
